(19) United States
(12) Patent Application Publication
(10) Pub. No.: US 2026/0225818 A1
(43) Pub. Date: Aug. 6, 2026

(54) RECESSED NOSEBAR FOR A CONVEYOR

(71) Applicant: Laitram, L.L.C., Harahan, LA (US)

(72) Inventors: Benny J. Boudreaux, IV, Harvey, LA (US); Benson Hall, Harahan, LA (US)

(21) Appl. No.: 19/149,186

(22) PCT Filed: Jan. 31, 2024
(86) PCT No.: PCT/US2024/013750

§ 371 Date: Jul. 18, 2025

Related U.S. Application Data
(60) Provisional application No. 63/442,803, filed on Feb. 2, 2023.

(51) Int. Cl. B65G 21/20; B65G 17/08

(52) U.S. Cl. CPC B65G 21/20; B65G 17/08

(57) ABSTRACT

A recessed nosebar for transitioning a conveyor belt at an end of a carryway comprises a bulbous transition end and a recess below and inset from the bulbous transition end to facilitate turning of the conveyor belt. The bulbous transition end is formed by a curved surface that extends from a horizontal flat surface forming an end of a carryway through an arc that spans more than 90° but less than 180° and transitions to a concave recess for spacing the conveyor belt from the nosebar during transitioning.

### RELATED APPLICATIONS

The present application claims priority to U.S. Provisional Patent Application No. 63/442,803, filed Feb. 2, 2023 and entitled “Recessed Nosebar for a Conveyor”, the contents of which are herein incorporated by reference.

### FIELD OF THE INVENTION

The present application relates to power-driven conveyors. More particular, the present invention relates to a nosebar for transferring product on a conveyor belt from a carryway and transitioning the conveyor belt from the carryway to a returnway.

### BACKGROUND OF THE INVENTION

Conveyor belts are widely used in various industries to convey products. Endless conveyor belts are generally trained around reversing elements, such as sprockets, pulleys, nosebars or noserollers, to form an endless circuit having a carryway and returnway. Modular plastic conveyor belts are constructed of a series of rows of side-by-side belt modules. Hinge eyes along opposite ends of each row interleave with hinge eyes of consecutive rows. A hinge rod inserted in the interleaved hinge eyes connects the rows together at hinge joints into an endless conveyor belt loop.

In a conveyor system, nosebars can be used to support a conveyor belt at an end of a carryway to enable transfer of small products and—or minimize a gap between the conveyor and another conveyor.

Current nosebar designs include static structures with a curved end that extends through 180° (a “full wrap” nosebar) in so that the belt does not contact the nosebar after turning. Other nosebar designs include a flat, angled wall extending from a curved end transition surface that extends through an arc of about 90°. Nosebars with a flat, angled wall tend to make line contact with the conveyor belt, which can create problems with load distribution.

### SUMMARY OF THE INVENTION

A nosebar for a conveyor comprises a bulbous transition end that protrudes from a base portion of the nosebar and a recess below and inset from the bulbous transition end to facilitate turning of the conveyor belt. The bulbous transition end is formed by a curved surface that extends from a horizontal flat surface forming an end of a carryway through an arc that spans more than 90° but less than 180° and transitions to a concave recess for spacing the conveyor belt from the nosebar during transitioning.

According to one aspect, a nosebar for a conveyor belt comprises a horizontal top surface forming an end of a carryway, a curved transition surface extending from the horizontal top surface through an arc that is between about 95° and about 175° to an inflection point below the horizontal top surface and a concave recess extending from the inflection point extending downwards and away from the curved transition surface.

According to another aspect, a nosebar for a conveyor belt comprises a horizontal top surface forming an end of a carryway, a bulbous end nose extending from the horizontal top surface and an angled front surface extending down and rearwards from the bulbous end nose.

### BRIEF DESCRIPTION OF THE FIGURES

These features and aspects of the invention, as well as its advantages, are better understood by referring to the following description, appended claims, and accompanying drawings, in which:

FIG. 1 is a side view of an output end of a conveyor, showing a conveyor belt traveling over a recessed nosebar according to an embodiment;

FIG. 2 is a side view of the recessed nosebar of FIG. 1;

FIG. 3 is an annotated view of the recessed nosebar of FIG. 2;

FIG. 4 is a detailed view of the recessed nosebar of FIG. 3;

FIG. 5 is a side view of another embodiment of a recessed nosebar and conveyor belt according to another embodiment; and

FIG. 6 is a side view of the recessed nosebar of FIG. 5.

### DETAILED DESCRIPTION OF THE INVENTION

A recessed nosebar for a conveyor facilitates transitioning of a conveyor belt between a carryway and a returnway. The invention will be described below relative to certain illustrative embodiments, though those skilled in the art will recognize that the invention is not limited to the described embodiments.

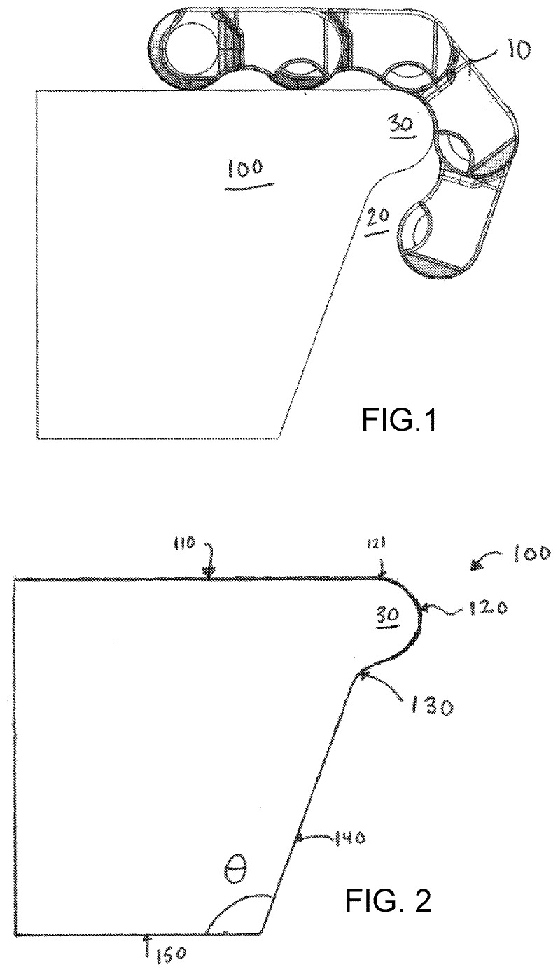

FIG. 1 shows an embodiment of a recessed nosebar 100 suitable for guiding a conveyor belt 10 between a carryway and a returnway. The illustrative recessed nosebar 100 is shaped to optimize the interaction between the conveyor belt 10 and nosebar contact surfaces, reducing contact pressure. The illustrative recessed nosebar 100 creates surface contacts between the recessed nosebar 100 and the conveyor belt 10 through the high load sections of articulation, eliminating or reducing line contact.

The illustrative conveyor belt 10 is a modular plastic conveyor belt comprising hingedly connected conveyor belt modules. The modules have a concave surface between hinge elements, but the invention is not so limited.

The illustrative recessed nosebar 100 forms a bulbous end nose 30 for transitioning the conveyor belt 10. The bulbous end nose 30 protrudes from a base portion of the nosebar 100. The bulbous end nose 30 provides a space 20 between the conveyor belt and the nosebar 100 as the conveyor belt transitions from the carryway to the returnway.

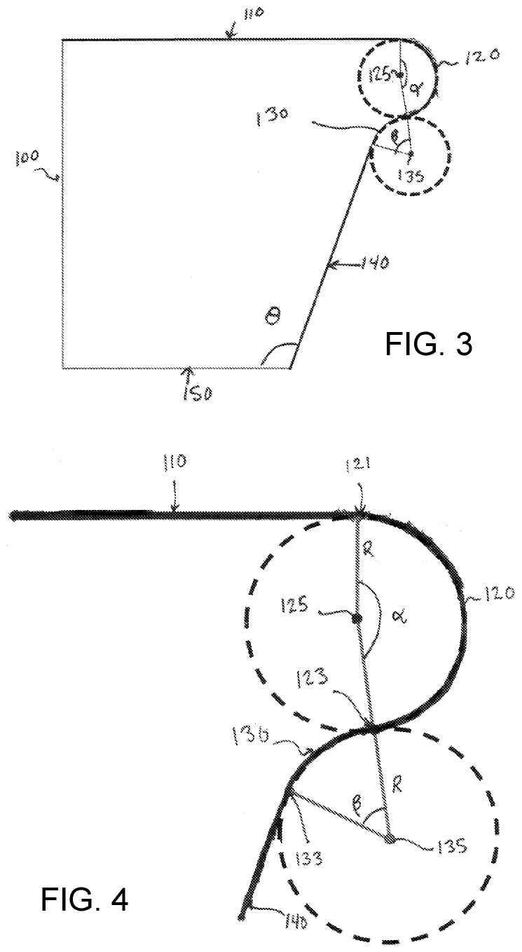

Referring to FIGS. 2-4, the illustrative nosebar 100 includes a horizontal flat top surface 110 forming an end of a conveyor carryway. At a transition point 121, the nosebar curves down to form a curved guide surface 120 defining the bulbous end nose 30 for transitioning the conveyor belt. The illustrative curved guide surface 120 curves through an arc that is between about 95° and about 175° (i.e., greater than 90° and less than 180°). In the illustrative embodiment, the curved guide surface 120 curves through an arc & that is between about 165° and about 175° and preferably about 170°, but the invention is not so limited. The curved guide surface 120 has a radius of curvature R that is consistent throughout the arc and a center of curvature 125 directly below the transition point 121.

At the end of the curved guide surface 120, the curved guide surface 120 inflects at inflection point 123 to form the recess 130, which is defined by a concave curved surface extending from inflection point 134 to end point 133. The inflection point 123 is forward of the transition point 121 and center of curvature 125 of the curved transition surface 120. The recess 130 pulls the contact surface of the nosebar 100 away from the path of the conveyor belt. The illustrative recess 130 has a radius of curvature R that is about equal to the radius of curvature of the curved guide surface 120, but the invention is not so limited and the recess 130 can have any suitable size, shape and configuration to provide space between the conveyor belt and the nosebar as the conveyor belt transitions from the carryway to the returnway. The illustrative recess 130 extends through an arc β that is between about 45° and about 65° and preferably about 55°, but the invention is not so limited. The recess 130 has a center of curvature 135 that is forward of the center of curvature 125 of the curved transition surface 120 and forward of the inflection point 123, but the invention is not so limited and the recess center of curvature 135 can be inset, or at another location.

At the end 133 of the recess 130, the nosebar surface transitions to an angled flat transition surface 140 that extends down towards the returnway and away from the bulbous end nose 30 and is set back from the curved guide surface 120. The illustrative angled flat transition surface 140 extends at an obtuse angle θ relative to a bottom horizontal surface 150 of the nosebar 100 that is between about 95° and about 130°, but the invention is not so limited. The illustrative angled flat transition surface 140 is inset from the forwardmost tip of the curved guide surface 120, but the invention is not so limited. Other suitable geometries for providing space in a transition area may also be used.

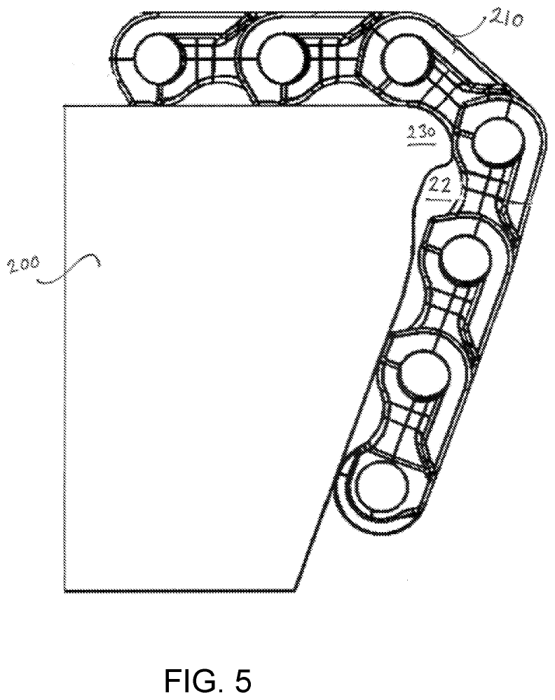

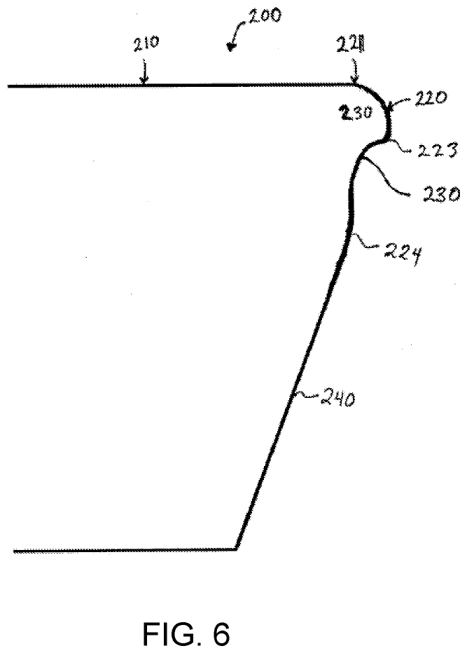

For example, as shown in FIGS. 5 and 6, a nosebar 200 having a protruding, bulbous nose 230 for optimizing contact with a conveyor belt 210 another shape and configuration. The bulbous end nose 30 provides a space 22 between the conveyor belt 210 and the nosebar 200 as the conveyor belt transitions from the carryway to the returnway.

The nosebar 200 includes a flat a horizontal flat top surface 210 forming an end of a conveyor carryway. At a transition point 221, the nosebar curves down to form a curved guide surface 220 defining the bulbous end nose 230 for transitioning the conveyor belt. The illustrative curved guide surface 220 curves through an arc that is between about 95° and about 105° to transition point 223, where the bulbous end nose 230 makes a sharper inflection than the bulbous end nose 30 to form a recess 230. The illustrative recess 230 curves to transition point 224 and has an asymmetric shape, but the invention is not so limited. At transition point 224, the nosebar 200 forms an angled flat transition surface 240. The embodiment of FIGS. 5 and 6 shifts the angled flat transition surface 240 forward relative to the embodiment of FIGS. 1-4 to provide support for the belt after the transition over the bulbous end nose 230. As shown, the angled flat transition surface 240 may extend along a plane that intersects or is close to the forwardmost tip of the bulbous end nose 230. The illustrative recess 230 recess is sized to span less than the pitch dimension of the conveyor belt 10, which will keep the conveyor belt properly constrained and prevent or reduce vibration. The radius to get back onto the angled flat transition surface 240 after the recess 230 may be relatively large to prevent snags if the conveyor belt does make intermittent contact there.

The invention has been described relative to certain illustrative embodiments, but the scope of protection is not limited to these illustrative embodiments.

What is claimed is:

1. A nosebar for a conveyor belt, comprising:
a horizontal top surface forming an end of a carryway;
a curved transition surface extending from the horizontal top surface through an arc that is between about 95° and about 175° to an inflection point below the horizontal top surface; and
a concave recess extending from the inflection point extending downwards and away from the curved transition surface.

2. The nosebar of claim 1, wherein the concave recess transitions to an angled flat transition surface extending to a bottom wall of the nosebar.

3. The nosebar of claim 2, wherein the angled flat transition surface extends along a plane that intersects a front tip of the curved transition surface.

4. The nosebar of claim 2, wherein the angled flat transition surface extends along a plane that is inset from a front tip of the curved transition surface.

5. The nosebar of claim 1, wherein the curved transition surface extends through an arc that is about 170°.

6. The nosebar of claim 1, wherein the curved transition surface has a radius of curvature of R and the concave recess has a radius of curvature equal to R.

7. The nosebar of claim 1, wherein the concave recess curves through an arc that is about 55°.

8. The nosebar of claim 1, wherein the concave recess has a center of curvature that is forward of a center of curvature of the curved transition surface.

9. The nosebar of claim 1, wherein the concave recess is asymmetrical.

10. A nosebar for a conveyor belt, comprising:
a horizontal top surface forming an end of a carryway;
a bulbous end nose extending from the horizontal top surface; and
an angled front surface extending down and rearwards from the bulbous end nose.

11. The nosebar of claim 10, wherein the bulbous end nose is formed by a curved transition surface that extends down from the horizontal top surface through an arc that is between about 95° and about 175° to an inflection point below the horizontal top surface and a concave recess extending from the inflection point extending downwards and away from the curved transition surface.

12. The nosebar of claim 11, wherein the concave recess curves through an arc that is about 55°.

13. The nosebar of claim 11, wherein the concave recess is asymmetrical.

14. The nosebar of claim 10, wherein the angled front surface extends along a plane that intersects a front tip of the bulbous end nose.

15. The nosebar of claim 10, wherein the angled front surface extends along a plane that is inset from a front tip of the bulbous end nose.
